(19) United States
(12) Patent Application Publication
(10) Pub. No.: US 2010/0215757 A1
(43) Pub. Date: Aug. 26, 2010

(54) ENVELOPE MEMBRANE FOR DISCHARGING AN ENCLOSED AGENT, METHOD FOR THE PRODUCTION THEREOF, AND USE THEREOF

(76) Inventors: Walter Polak, Salzburg (AT); Kurt Beining, Berlin (DE)

Correspondence Address: FAY SHARPE LLP, 1228 Euclid Avenue, 5th Floor, The Halle Building, Cleveland, OH, 44115, US

(21) Appl. No.: 12/160,646

(22) PCT Filed: Dec. 21, 2006
(86) PCT No.: PCT/EP06/12383

§ 371 Date: Mar. 29, 2010

(30) Foreign Application Priority Data
Jan. 11, 2006 (DE) 10 2006 001 481.2
Jul. 20, 2006 (DE) 10 2006 033 654.2

(51) Int. Cl. A01N 25/28; C02F 1/50; A01N 1/00; B01J 13/02

(52) U.S. Cl. 424/493; 424/490; 424/661; 424/497; 264/4.1

(57) ABSTRACT

The invention relates to an enveloping membrane for discharging an enclosed agent in an aqueous medium. The aqueous solution of an oxidizing chlorine-oxygen compound is enclosed is said enveloping membrane which is insoluble in a neutral aqueous medium. In an advantageous embodiment, the enveloping membrane represents a capsule structure, particularly according to the core/shell principle. The core has a spongy, moist structure and contains the aqueous solution of an oxidizing chlorine-oxygen compound while the shell is water-insoluble and is provided with pores to discharge the chlorine-oxygen compound over an extended period of time, particularly in an aqueous medium. The enveloping membrane is suitable foremost for disinfecting and purifying/cleaning liquids and substrate surfaces, especially in the form of fabrics, filter materials, membranes, gaps, joints, and/or filling elements, for disinfecting water, particularly drinking water and bath water, and filter materials, where the inventive enveloping membrane discharges the agent into the medium or onto the substrate that is to be treated for an extended period of time, especially in a continuous and metered form.

The invention relates to an enveloping membrane for discharging an enclosed agent in an aqueous medium, to a method for the production of an advantageous development of this enveloping membrane and to the use thereof for the disinfection and purification of liquids and of substrate surfaces and for the disinfection of water.

Oxidising chlorine-oxygen compounds for the disinfection and purification of liquids, especially for the disinfection of drinking water and bathing water, and also of substrate surfaces, especially filter materials, membranes and the like have been known for years. Chlorine especially, also bound into chemical compounds, is used effectively to treat water. Thus, chlorine is used for disinfection and algae control in the treatment of water to produce drinking water and industrial water. Chlorine bound into sodium hypochlorite is used for the same purpose. The use of sodium hypochlorite in water treatment is controlled by DIN regulations. For disinfecting drinking water, only those processes are considered which work reliably, do not impair the quality of the drinking water and which can be carried out at a reasonable cost in technological terms. In addition to chlorine and sodium hypochlorite mentioned above, the order governing treatment of drinking water in force in the Federal Republic of Germany also authorises the following substances: calcium hypochlorite, chlorinated lime, magnesium hypochlorite, chlorine dioxide, ammonia and ammonium salts as well as ozone. Chlorine is the most widely used disinfectant for drinking water. In the “indirect chlorine gas process” which is common practice today, a chlorine solution is initially prepared and then added to the water. The chlorine action competes with the oxidising action of the chlorine in respect of inorganic and organic constituents (chlorine demand) with the time-dependent disinfecting action.

In individual cases, the use of chlorine dioxide is advantageous. It can only be produced directly at the addition site, it being necessary to avoid a formation in water of chlorite which is detrimental to health. Although ozone has a substantially stronger disinfection action, here again the oxidation of organic constituents competes with the disinfection.

For some time, the development of chlorine-containing water treatment agents has been concerned with the question of how far advantages could be achieved here in respect of bonding chlorine into a chemical substance. Developments of this type are described in WO 02/098791 A1: thus, according to the teaching described therein, a stable chlorine-oxygen solution in particular is to be prepared which optimally satisfies the requirements for water treatment, especially in swimming pools, in other words which can be applied without toxicological reservations, which is friendly to the environment, which is economically feasible and highly suited from an application technology aspect. An advantageous substantially chlorite-free, stable aqueous chlorine-oxygen solution of this type is prepared as follows: a hydrogen sulphate compound is initially dissolved in water. An acid is then added to the aqueous solution containing hydrogen sulphate in a quantity such that the pH in the desired end product in the form of the substantially chlorite-free, stable aqueous chlorine-oxygen solution is maintained between approximately 3 and 5; a peroxide compound is then added. An aqueous chlorite solution is then added dropwise in a quantity of approximately 60 to 90 mol % of chlorite, based on the concentration of peroxide compound.

All the aforementioned chlorinating agents, whether with bound or non-bound chlorine, suffer from the basic problem that the active substance is consumed very rapidly and cannot be released long-term to the desired extent and especially in a metered manner. Thus, the aim of the present invention was to provide an advantageous remedy to this problem.

According to the invention, this aim is addressed by an enveloping membrane for discharging an enclosed agent in aqueous media such that an aqueous solution of an oxidising chlorine-oxygen compound is enclosed and the enveloping membrane is insoluble in a neutral aqueous medium.

The feature “enveloping membrane” is to be understood in the broadest possible sense. Thus, it can be a plastics material film, for example a pouch made of plastics material films which contains the respective agent. All that remains is the necessary containment. It is also possible, as shown in the following, for capsules or microcapsules to be understood as an “enveloping membrane”. The decisive factor is that the agent concerned is enveloped or encapsulated in an aqueous medium.

The term “membrane” is also relevant in connection with the enveloping material. This should express the fact that in the respective applications, the membrane as such is permeable to gas and/or water. In individual cases, the enclosed agent can be released in gas form in the enclosed aqueous medium with the adjustment of specific conditions. In these cases, the respective enveloping material, especially a thermoplastic plastics material is permeable to gas. In other cases, the agent is not in gas form, so that together with the aqueous medium in which it is present, it passes through the water-permeable membrane, which takes place especially through micropores. In connection with an oxidising chlorine-oxygen compound, it is possible in this respect for an equilibrium, for example to be adjusted between said oxidising chlorine-oxygen compound and released chlorine dioxide and oxygen. These are then gaseous decomposition products which pass through the gas-permeable membrane in question into the medium to be treated to be effective there. If a decomposition of this type does not take place, the oxidising chlorine-oxygen compound as such, preferably as TCDO, is to pass into the medium to be treated. The desired water permeability or porosity will be adjusted here in an expert manner. A case of this type is also called a “stable, oxidising chlorine-oxygen compound” which is of especial practical significance in the realisation of the present invention. In this case, the desired water-permeability or porosity of the capsules will be adjusted in an expert manner. In any case, the “enveloping membrane” feature makes it clear to a person skilled in the art that a permeability, produced in any manner, is to be provided for the respective agent.

Generally speaking, the enveloping material is “water-insoluble”. However, the water-insolubility is to apply especially to a neutral aqueous medium. In connection with a porous enveloping material, it is possible to particularly adjust the metered addition by adjusting the respective pore size or porosity of the enveloping material. Especially, when the enveloping membrane according to the invention is used, it ensures that the enclosed agent is discharged in the broadest sense in a continuous and also metered manner, the aforementioned control possibilities existing, especially the adjustment of optimum porosity for the respective application.

There are diverse possibilities for advantageously modifying the enveloping membrane according to the invention or the material which forms the envelope: thus, in individual cases, it is appropriate to add additives to the enveloping membrane to vary the characteristics. In this respect, the additives can be those which harden the film, for example, which forms the enveloping membrane, thus especially by including salts, especially alkali metal and/or alkaline-earth metal salts. Calcium chloride is preferred in this respect. Moreover, it is possible to add as additives pH, redox and/or conductivity-sensitive reagents, especially phenolphthalein or methyl orange. If, for example, the density of the enveloping membrane is to be reduced, it is appropriate to include additives in this respect, such as especially silicon dioxide, porous materials, such as especially bentonite and/or activated carbon. Using the aforementioned general instructions in respect of the enveloping membrane according to the invention, it is very easy for a person skilled in the art to form materials or especially films suitable for the respective application to achieve the desired purpose.

A preferred idea for the production of the enveloping materials is to base the respective envelope on cationic and/or anionic water-insoluble polymers. Cationised and/or anionised polyelectrolytes are preferred, especially cationised and/or anionised polysaccharides. The cationic polyelectrolyte is a plastics material, such as especially poly(meth)acrylic acid. Included among the more preferred cationised and/or anionised polysaccharides are chitosan or chitosan derivatives or alginate or alginate derivatives. As will be discussed in more detail later on, these play an especial part when the enveloping membrane follows the so-called core/shell principle. The enveloping material then has an outer shell with an inner core. In such a case, the aqueous solution of the stable, oxidising chlorine-oxygen compound is not in a normal aqueous medium, but is enclosed in the core which is present especially in the form of a moist sponge.

The agent enclosed in an enveloping membrane and released within the scope of the invention is an oxidising chlorine-oxygen compound, especially a stable compound which is enclosed in the enveloping membrane in an aqueous solution. The oxidising chlorine-oxygen compound is preferably substantially free from chlorite. It is especially advantageous for it to be present as a so-called tetrachlorodecaoxide complex. For a better understanding of the present invention, the following explanations intend to deal extensively with the particular type of oxidising chlorine-oxygen compound enclosed in the enveloping material according to the invention in an aqueous solution, especially in a stable form:

The invention is not subject to any relevant restriction in respect of the oxidising chlorine-oxygen compound. The chlorine-oxygen compounds which are described in the aforementioned WO 02/098791 A1 are especially advantageous. In this respect, reference is also made to the production process previously presented in the discussion of the prior art. The stable chlorine-oxygen compounds described in WO 02/098791 A1 are termed modified and are characterised in that they do not contain any free chlorine. The significance of the capsules according to the invention is not restricted by the fact that in an individual case, free chlorine is nevertheless present. In respect of systems which are as simple as possible, energy-saving and environmentally friendly, correspondingly modified oxygen carriers in the form of chlorine systems are advantageous in the field of water treatment, especially in swimming pool technology, which do not contain free chlorine which is very aggressive and can lead to undesirable by-products. An especially advantageous “modified” chlorinating agent is the TCDO complex anion which, according to the teaching of WO 02/098791 A1, can be obtained in aqueous medium. This is obtained in the aforementioned pH range of between approximately 3 and 5 and can be detected by an initial brown colour using the charge transfer complex Cl₄O²⁻₁₀, after which a yellow-green colour appears which resembles in colour the much lighter coloured yellow-green solution colouring of the tetrachlorodecaoxide complex. Hidden below the tetrachlorodecaoxide complex anion is a relatively complex charge transfer structure, according to which oxygen is contained dissolved in a chlorodioxide-chlorite matrix and is present stabilised in an active form.

The so-called TCDO complex was detected by modern analytical methods, for example using Raman spectroscopy. The TCDO complex is used here especially advantageously if it is present in aqueous solution and was obtained especially by the process described in WO 02/098791 A1. This is essential for its stability. Thus, chlorite and chlorate could no longer be detected in an aqueous solution of the TCDO complex. This technological explanation is not intended to be restrictive.

The aforementioned oxidising chlorine-oxygen compound, especially in the form of TCDO is not critically restricted in respect of the concentration in the aqueous solution enclosed in the enveloping membrane. It is preferred if the enclosed aqueous solution of the chlorine-oxygen compound contains approximately 40 to 100 g/l, especially approximately 50 g/l of stable oxidising chlorine-oxygen compound, especially in the form of TCDO.

It has already been shown that the central idea of the invention can be realised in a relatively abstract form in practice. It has been shown that when the enveloping membrane is present in the form of capsules, especially in the form of microcapsules, it can be used for especially advantageous application purposes. In this case, the outer shell can be traced back especially to a cationic (cationised) polyelectrolyte and the inner core can be traced back to an anionic (anionised) polyelectrolyte, especially to a cationised and/or anionised polysaccharide, or vice versa.

There is a plethora of literature references which are concerned with the production of capsules of the described type, in which the core is based on an alginate or alginate derivative and the shell is based on chitosan or a chitosan derivative. The reference “Pharmaceutical Engineering”, November/December 2002, Volume 22, No. 6, deals at length with this subject under the heading “Perm-Selective Chitosan-Alginate Hybrid Microcapsules for Enzyme Immobilization Technology”. Thus, according thereto, for example 2 g of a sodium alginate are dissolved in 100 ml of distilled water and stirred for a relatively long time. Thereafter, small calcium alginate balls are produced by adding the alginate solution dropwise through a needle into a 0.34 M calcium chlorite solution. These balls are suspended in a chitosan solution, which results in the production of microcapsules. More extensive modification measures can be taken (loc. cit. page 2, column 1, “Preparation of Chitosan-Alginate Hybrid Microcapsules”). A corresponding process is presented in “J. Microencapsulation”, August 2004, Volume 21, No. 5, 485-497. In this respect, it is also possible to refer to “Biomaterials”, April 1999, 20(8): 773-83. Here, a further production method is proposed in that initially no solid core is formed and thereafter the shell is constructed from chitosan, but two solutions of the starting materials are provided for the core and shell. Thus, a solution of sodium alginate is added dropwise into a chitosan solution, all the chitosan forming on the surface on a thin alginate-chitosan membrane. A two-stage process is also described, according to which small calcium-alginate balls are treated in an aqueous solution of chitosan and calcium chlorite, thus producing capsules which have a high mechanical strength. In addition, it is known from “Journal of Bioactive and Compatible Polymers”, Volume 18, No. 3, 207-208 (2003) to continuously produce chitosan-alginate microcapsules by a so-called “air extrusion method”. Finally, reference is also made to “International Journal of Pharmaceutics”, 187 (1999) 115-123. This publication discusses the microencapsulation of lipophilic agents in small chitosan-coated alginate balls.

As already indicated, polysaccharides are especially significant in the realisation of the present invention according to the core/shell principle, especially in the form of alginate and/or chitosan or derivatives thereof. A person skilled in the art is familiar with these substances. Included among chitosan derivatives are, for example chitosan HCl or chitosan lactate, chitosan acetate, carboxymethyl chitosan. Polysaccharides are understood especially as meaning modified starches and celluloses, for example in the form of their carboxylate compounds, such as in the form of acetates, propionates or butyrates, but also for example in the form of sulphates and phosphates. There are diverse expert measures for the necessary and desirable modification of starch and cellulose: thus, polysaccharides can be partially decomposed and partially oxidised by an oxidising agent and then converted into a polyelectrolyte complex by a chemical reaction under heat with polyaminoglucose. Oxidising agents suitable for ionising polysaccharides include, for example chromo-sulphuric acid, ozone and hydrogen peroxide. This produces a sufficient acid proportion in the polysaccharides. This reaction can also be catalysed, for example with a cobalt-nickel solid metal catalyst. It is also possible to modify the polysaccharides by grafting, for example acrylic acid or derivatives thereof. Included among the graft copolymers of starch are, for example starch/acrylamide/acrylic acid graft copolymers. Furthermore, the respective polysaccharides can be carboxylated, especially actylated, preferably with acetic acid anhydride.

The following especially are mentioned as reaction products of the modification process: anionic and cationic starch ethers, starch esters, such as xanthogenates, acetates, phosphates, sulphates and nitrates as well as carboxy starch. Accordingly, here the hydroxyl group of the starch or cellulose has been converted in the conventional manner into a suitable ionised compound for the purpose of the invention by, for example etherification, esterification or by selective oxidation or by a radically initiated graft copolymerisation reaction. Furthermore, hydroxyethyl starch and hydroxypropyl starch are mentioned as modified starches. Also suitable are cationic starches which are present in the form of starch ethers and which result from the alkaline reaction of starch with reagents containing amino or quaternary ammonium groups. The following can also be mentioned as established etherification agents: (2-chloroethyl-diethyl amine, (2,3-epoxypropyl)diethyl amine, (3-chloropropyl)trimethylammonium chlorite, (3-chloro-2-hydroxypropyl)trimethylammonium chlorite, (2,3-epoxypropyl)trimethylammonium chlorite and (4-chloro-2-butenyl)trimethylammonium chlorite. The procedural possibilities described above in connection with the ionisation of starches apply accordingly to the same extent to the ionisation of other polysaccharides, especially also of cellulose. The ionisation presented above of polysaccharides is basically pure specialised knowledge. In this respect, reference is made, for example to RÖMPP “Chemielexikon”, 9^{th} Edition, Volume 3, page 2180.

Irrespective of the type of polysaccharides suitable within the scope of the invention, the following can also be stated concerning the capsules of the core/shell principle: in general, the core preferably exhibits a spongy, moist structure in which the aqueous solution of the stable oxidising chlorine-oxygen compound is contained, while the shell is insoluble in water and allows the metered discharge of the oxidising chlorine-oxygen compound through pores. In this case, as will be shown in the following, the shell can comprises a chitosan or chitosan derivative and the core can comprises an alginate or alginate derivative, or vice versa. These polysaccharides are present in oppositely ionised form during the production of the capsules. This means that in the production process described in the following, the chitosan and/or the alginate or respective derivative is predetermined and contains the stable oxidising oxygen compound in aqueous solution, while the solution of the material subsequently added dropwise is the chemical opposite. In other words: the core comprises alginate and/or derivative and the shell comprises chitosan and/or chitosan derivative.

In practical use, it has proved appropriate for the microcapsules concerned to have a particle size of approximately 1 to 500 μm, especially approximately 5 to 200 μm. In particular cases, the capsules are present as so-called nanocapsules, preferably with a particle size of approximately 100 nm to 1 μm, especially with a particle size of approximately 150 to 650 nm. In an advantageous realisation of the enveloping material according to the invention based on the core/shell principle, it has been found that the ratio of the wall thickness of the shell to the diameter of the core is approximately 1:1 to 1:10, especially approximately 1:1 to 1:5. Furthermore, it is advantageous in this particular embodiment of the invention if the aqueous solution of the stable oxidising chlorine-oxygen compound makes up approximately 20 to 80% by weight, especially approximately 30 to 60% by weight of the core.

The following is also to be stated in detail in respect of the preferred embodiments, described above, of the inventive enveloping material, based on the core/shell principle using chitosan and/or a chitosan derivative on the one hand and alginate respectively and/or an alginate derivative on the other hand:

Capsules of the type described above, in which the core is composed of an alginate and/or an alginate derivative and the solid outer shell is composed on the basis of chitosan and/or a chitosan derivative are known in the prior art. When alginates are mentioned within the scope of the invention, they are understood as meaning especially salts of alginic acid, especially sodium, potassium, ammonium and magnesium salts which have the necessary solubility in water during the production of the capsules according to the invention. When “alginate derivatives” are mentioned, these are modifications, for example etherifications of the hydroxyl groups of alginic acid into, for example methoxy groups and similar groups which do not substantially impair the desirable water-solubility during the production of the capsules according to the invention. It is especially to be considered that the alginate is present in the form of an alginate anion and reacts accordingly during the production of the capsules of the invention according to the advantageous inventive method described in the following. Chitosan which is considered according to the invention for the formation of the shell, is obtained from natural chitin by deacetylation of the amide bond, it being possible to control the degree of deacetylation (DDA). During production, the chain length and molecular weight of the chitosan oligosaccharides can be precisely adjusted. Within the scope of the invention, chitin is also to be assessed as chitosan derivative. In this case as well, possibilities exist to carry out modifications into derivatives, for example by etherification of the hydroxyl groups of the saccharide skeleton. As described in the following in connection with the description of the method according to the invention for the production of the inventive capsules, to adjust the necessary water solubility, the chitosan or chitosan derivative which is insoluble per se is made water soluble in that it is in a weakly acidic medium which results in the amino group being more or less protonised and consequently a “cationic component” promoting water solubility is present.

As a result, it is to be stated that capsules of the described type are already known in principle (core/shell principle). It is judged as being surprising that according to the invention, the underlying object can be achieved in that the core of the capsules substantially contains the aqueous solution of a stable, oxidising chlorine-oxygen compound, the core having a spongy, moist structure. These capsules can be stored for a long period of time, without the efficiency of the enclosed chlorine-oxygen compound being substantially impaired. This applies especially when these capsules are stored in an aqueous medium which already contains a stable oxidising chlorine-oxygen compound which is generally subject to a more rapid decomposition than the compound which contains chlorine and oxygen and is enclosed in the capsules. It would be quite possible to assume that the chlorine-oxygen compound in an aqueous solution which is inside the spongy structure of the core decomposes equally rapidly according to conventional decomposition mechanisms as in a free aqueous medium. Thus, the capsules according to the invention can be stored for a prolonged period of time. Especially in the applications described in detail later on, the chlorine-oxygen compound is discharged in a desired form and metered through the pores of the shell of the capsules according to the invention

When it was presented above which surprising results occur when the enveloping material according to the invention is used in the form of capsules, a person skilled in the art can immediately see that they appear equally for the abstract “enveloping membrane” concept of the invention, i.e. not based on the core/shell principle.

Further information about the capsules according to the invention: it is advantageous if the shell, which has pores, of the capsules is hardened in individual cases. To increase the hardness, it is advantageous to bind in salts, especially alkali and/or alkaline earth metal salts, such as sodium, potassium, magnesium and/or calcium salts. The hardening is achieved in that during production, the respective hardening salts are added to the starting solution and/or to the reactive end solution. The use of calcium salts is especially advantageous, especially in the form of calcium chloride. The characteristics of the shell and/or core can furthermore be controlled in a desirable manner if other suitable additives are included during production of the capsules. Thus, such additives can be, especially additives for increasing the strength and/or density, as already mentioned above, but also pH, redox and/or conductivity-sensitive reagents. In this respect, silicon dioxide and/or bentonite in particular are advantageous. This advantageous control possibility is able to give the capsules a varying specific weight. Thus, it is advantageous in different cases for the capsules to be given a density of less than 1 g/ml to float in an aqueous medium and a density of more than 1 g/ml to sink or float in an aqueous medium. Moreover, it is possible to not only include additives or substances during the production of the capsules which influence specific characteristics of the core and/or shell, but also those which exhibit additional desirable outer effects for the particular possibilities of use which are still to be mentioned, such as an increase in the adsorptive characteristics. The adsorptive characteristics are promoted by incorporating activated carbon into the shell and/or core, especially the shell. It is also especially advantageous if reagents are included which exhibit a colour change during the metered discharge of the chlorine-oxygen compound, when its effective discharge abates, the use of phenolphthalein or methyl orange being especially advantageous.

The following is mentioned in respect of a further technological elaboration of the capsules according to the invention, although no binding technological explanation is to be seen therein: within the scope of the production of the capsules according to the invention, an alginate for example is used which contains an anionic component, namely an alginate component. In contrast thereto, chitosan, used in a weakly acidic aqueous medium for the production of the capsules, is provided with a cationic component, namely in the form of the protonised chitosan skeleton. There presumably occurs at the interface between core and shell a cross-linking reaction, i.e. the anionic components of the alginate and the cationic components of the chitosan enter into a cross-linking interaction. This obviously has advantageous effects on the stability and the metering ability of the capsules according to the invention.

A person skilled in the art is already able to infer from the explanations given above how the enveloping membrane according to the invention can be produced. This also applies to the capsules which are based on the core/shell principle. If the cationised and/or anionised polysaccharide in the capsules according to the invention is a chitosan or chitosan derivative or an alginate or alginate derivative, the method is preferably such that a) the aqueous solution of the stable oxidising chlorine-oxygen compound is mixed into an aqueous solution of an alginate or of an alginate derivative, an aqueous solution of chitosan or a chitosan derivative is mixed into the resulting mixture and the reaction mixture obtained is converted into capsules, or b) the aqueous solution of the stable oxidising chlorine-oxygen compound is mixed into an aqueous solution of a chitosan or of a chitosan derivative, an aqueous solution of alginate or an alginate derivative is mixed into the resulting mixture and the reaction mixture obtained is converted into microcapsules. Consequently, in this processing mode, according to whichever modification, the component which forms the core ionises in a different manner compared to the component which forms the shell. In any case, a different ionisation should be present, i.e. one component must be anionised and the other must be cationised. Consequently, on the one hand, the chitosan or chitosan derivative can form the shell and the alginate or alginate derivative can form the core, and on the other hand it can also be the other way round. This depends only on the described reaction conditions.

It is also possible that the enveloping material is a capsule which does not follow the core/shell principle. In this case, water is initially in the shell and it exits through the pores of the hollow balls by drying, for example while observing the contained colour, so that the shell is free from water and only contains air. A person skilled in the art is easily able to fill capsules of this type with an aqueous solution of a stable, oxidising oxygen compound, in particular with an aqueous TCDO solution. Furthermore, it is also quite possible and easy to realise in practical terms if, when applying the core/shell principle, a material other than an organic-based material is used. Thus, this material could also be composed inorganically, for example could be present based on silicone materials or glass materials.

However, what is preferred, as already established, is a capsule with core and shell using alginate or alginate derivative on the one hand and chitosan or chitosan derivative on the other hand. In this respect, alginate could then be the anionic polyelectrolyte, while chitosan is the cationic polyelectrolyte. While bearing this in mind, the pH of the respective reaction medium plays a part as to whether an alginate shell is formed on the outside or whether an alginate core is formed on the inside. The fact whether, for example, the TCDO is in an aqueous acidic medium or in an alkaline medium has implications. If the TCDO is in an acidic aqueous medium, it interacts chemically with the anionic alginate. A solution of this type is presented and the cationic chitosan solution is then added dropwise. In so doing, a core forms from the alginate, regularly with a spongy structure, and a shell forms from chitosan. If an alkaline TCDO is presented which is added to the solution of the cationic chitosan and the anionic alginate is then added dropwise into the solution, reverse relationships take place, i.e. a core of chitosan is formed and a shell of alginate. Which structure is preferred in the core/shell principle depends on the respective application, namely on the pH which prevails in the application outside the capsules according to the invention and the like. In swimming pools, the pH is generally neutral or higher, so that in this case capsules are preferably considered in which alginate is the material of the shell. As already mentioned, it is also possible for a hollow ball (accordingly shell=membrane) to be formed using chitosan and/or alginate alone. In the case of chitosan (cationic), the TCDO solution would have to be adjusted so that it was alkaline. If alginate was used to form a hollow ball of this type, then the aqueous TCDO solution would have to be acidic.

In order to obtain the capsules with core/shell after carrying out the inventive method described above, the second component (aqueous solution of chitosan or chitosan derivative or of alginate or alginate derivative) is preferably mixed in by adding dropwise. There is a possibility of carrying out a specific “two phase spray drying” process. This is carried out as follows: solution A (e.g. alginate solution) is sprayed through a core nozzle and solution B (e.g. chitosan solution) is sprayed through a further, enveloping nozzle into a drying chamber. The result of using the outer nozzle is that the material issuing therefrom envelopes the drops which enter the drying chamber from the inner nozzle.

When realising the present invention according to the core/shell principle using alginate or alginate derivative on the one hand and chitosan or chitosan derivative on the other hand, it is preferred for optimising the respective products that one aqueous solution is adjusted to a concentration of approximately 0.5 to 10% by weight, especially approximately 0.5 to 4% by weight of alginate or alginate derivative and/or the other aqueous solution is adjusted to a concentration of approximately 0.5 to 4% by weight, especially approximately 0.5 to 2% by weight of chitosan or chitosan derivative. Depending on how the method according to the invention is controlled, it is advantageous to add additives to the aqueous solution which results in formation of the shell, thus for example to the aqueous solution of chitosan or chitosan derivative, if the shell is produced therefrom.

A person skilled in the art can readily see that the invention uses known method technologies in respect of the method for the production of the enveloping material according to the invention, especially in the form of capsules, regarding which reference is made, for example to the literature reference “Biomaterials”, 1999, April; 20(8): 773-83.

The enveloping materials according to the invention, especially the capsules according to the invention can be used for diverse purposes which focus on the efficiency of oxidising chlorine-oxygen compounds, especially in a stable form, especially for the disinfection and purification of liquids and substrate surfaces, especially for the treatment of fabrics, filter materials, membranes, narrow gaps, joints or filling elements. To the fore is an effective water disinfection, especially the disinfection of drinking and bathing water, as well as the disinfection of filter materials, especially in the form of quartz, silica sand and/or carbonaceous materials. In this respect, a simple and effective metering of the enclosed compounds containing chlorine and oxygen is possible, as is an advantageous handling of the capsules. These capsules can be applied without toxicological reservations, are friendly to the environment, economically feasible and are cost-effective to produce.

It is an advantage that the capsules according to the invention as nanocapsules can be supplied dry as powder. They can be easily dispersed in water and can be applied to narrow areas via a spray nozzle, thus into very narrow gaps, joints and the like. Relatively large capsules can be applied to filling elements or, for example to membranes and diverse other materials. A particular advantage is that the capsules according to the invention can be dyed. Thus, it is possible to determine from the degree of decolouration of the capsules that the concentration of agent has fallen below a certain measure. It is also possible to use the capsules according to the invention as a free-floating filter additive. They exhibit a desirable high thermal stability, thus between approximately 4 and 70° C. Moreover, when their efficiency has diminished, they can be disposed of in an advantageous manner, especially as they are environmentally friendly. As a result, they can be prepared for new purposes of use, although with some expense, in that they are stored for a certain period of time in an aqueous solution which contains the agent in the form of the oxidising chlorine-oxygen compound. The original state of efficiency is reproduced by diffusion procedures. The capsules according to the invention can be stored for a long period of time, without their efficiency being substantially impaired. To optimise this efficiency for the respective application, the capsules can be stored in an aqueous medium which already contains a chlorine-oxygen compound, especially the oxidising chlorine-oxygen solution already contained in the capsules in a relatively low concentration.

The invention will be explained in more detail in the following on the basis of an example which relates to the production of capsules, in this case the core/shell principle being realised with the use of alginate and chitosan.

### EXAMPLE

1. Preparation of a stable aqueous solution containing chlorine and oxygen: 2 g of sodium hydrogen sulphate are dissolved in 800 ml of water. 12 ml of 10 N sulphuric acid are then added. In addition, 38 ml of 30% hydrogen peroxide solution are carefully stirred in. 157 ml of sodium chlorite solution (25%) are added dropwise to this solution over a period of 15 min. The solution changes colour from brown to yellow-green and remains stable. Based on an analytical investigation, it was possible to establish that the solution contains the tetrachlorodecaoxide complex (TCDO complex) in a stable form.

2. Production of the capsules according to the invention: an aqueous solution, prepared according to the above method, of a sodium tetrachlorodecaoxide was used for encapsulation. 100 ml of the aqueous solution of the TCDO compound were presented, the TCDO compound being contained in a quantity of approximately 50% by weight. These 100 ml of aqueous solution of the chlorine-oxygen solution were added dropwise with slow stirring to 100 ml of a sodium alginate solution of a concentration of approximately 3% by weight. The mixture obtained in this way was added dropwise with stirring to 100 ml of a weakly acidic aqueous solution of chitosan of a concentration of approximately 3% by weight. After a reaction time of approximately 90 min, capsules of a particle size of approximately 60 m μm were produced. These capsules are particularly suitable for the treatment of swimming pool water when incorporated into the filter materials.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. An enveloping membrane for discharging an enclosed agent in an aqueous medium, characterised in that enclosed in the enveloping membrane is an aqueous solution of an oxidising chlorine-oxygen compound which is a substantially chlorite-free, stable aqueous chlorine-oxygen compound, the enveloping membrane is insoluble and water-permeable in a neutral aqueous medium and contains additives in the form of hardening salts.

30. An enveloping membrane according to claim 29, characterised in that the hardening salts are included in the form of alkali and/or alkaline earth metal salts, especially calcium chloride.

31. An enveloping membrane according to claim 29, characterised in that it is permeable to gas for decomposition products, released from the chlorine-oxygen compound, of the chlorine-oxygen compound, especially for chlorine dioxide and oxygen.

32. An enveloping membrane according to claim 29, characterised in that the enclosed agent is discharged in the form of the oxidising chlorine-oxygen compound in a continuously metered manner.

33. An enveloping membrane according to claim 29, characterised in that the chlorine-oxygen compound is present in the form of the tetrachlorodecaoxide complex.

34. An enveloping membrane according to claim 29, characterised in that the enveloping membrane has pores for the discharge of an oxidising chlorine-oxygen compound.

35. An enveloping membrane according to claim 29, characterised in that it contains additives in the form of pH, redox and/or conductivity-sensitive reagents, especially phenolphthalein or methyl orange.

36. An enveloping membrane according to claim 29, characterised in that it contains additives in the form of silicon dioxide, porous materials, such as especially bentonite and/or activated carbon, for reducing density.

37. An enveloping membrane according to claim 29, characterised in that it is based on cationic and/or anionic water-insoluble polymers.

38. An enveloping membrane according to claim 37, characterised in that the cationic and/or anionic water-insoluble polymers are present in the form of cationised and/or anionic polyelectrolytes, especially cationised and/or anionised polysaccharides.

39. An enveloping membrane according to claim 38, characterised in that the cationised polyelectrolyte is a plastics material, especially poly(meth)acrylic acid.

40. An enveloping membrane according to claim 29, characterised in that the enveloping membrane is present in the form of capsules, especially in the form of microcapsules, the solid outer shell being based on a cationic polyelectrolyte and the inner core being based on an anionic polyelectrolyte, or vice versa.

41. An enveloping membrane according to claim 40, characterised in that the microcapsules have a particle size of from approximately 1 to 500 μm, especially from approximately 5 to 200 μm.

42. An enveloping membrane according to claim 40, characterised in that the microcapsules are present as nanocapsules of a particle size of from approximately 100 nm to 1 μm, especially from approximately 150 to 650 nm.

43. An enveloping membrane according to claim 38, characterised in that the cationised and/or anionised polysaccharide is chitosan or a chitosan derivative or alginate or an alginate derivative.

44. An enveloping membrane according to claim 40, characterised in that the ratio of the wall thickness of the shells of the capsules to the diameter of the core is approximately 1:1 to 1:10, especially approximately 1:1 to 1:5.

45. An enveloping membrane according to claim 40, characterised in that the aqueous solution of the oxidising chlorine-oxygen compound makes up approximately 20 to 80% by weight, especially approximately 30 to 60% by weight of the core.

46. An enveloping membrane according to claim 29, characterised in that the enclosed aqueous solution contains approximately 40 to 100 g/l, especially approximately 50 to 80 g/l of oxidising chlorine-oxygen compound, especially in the form of TCDO.

47. Use of the enveloping membrane according to claim 29 for the disinfection and purification of liquids and substrate surfaces, especially fabrics, filter materials, membranes, narrow gaps, joints or filling elements.

48. Use of the enveloping membrane according to claim 29 for the disinfection of water, especially for the disinfection of drinking and bathing water, as well as for the disinfection of filter materials, especially in the form of quartz gravel, silica sand and/or carbonaceous materials.

49. A method for the production of enveloping membranes according to claim 43, characterised in that a) the aqueous solution of the oxidising chlorine-oxygen compound is mixed into an aqueous solution of an alginate or an alginate derivative, an aqueous solution of chitosan or of a chitosan derivative is mixed into the resulting mixture and the reaction mixture which is obtained is converted into capsules or b) the aqueous solution of the stable oxidising chlorine-oxygen compound is mixed into an aqueous solution of a chitosan or a chitosan derivative, an aqueous solution of alginate or of an alginate derivative is mixed into the resulting mixture and the reaction mixture which is obtained is converted into microcapsules, the alginate or the alginate derivative on the one hand and the chitosan or chitosan derivative on the other hand being used in an oppositely ionised manner and hardening salts are incorporated into the starting solution(s) and/or the final reaction mixture to adjust desirable characteristics.

50. A method according to claim 49, characterised in that the method of spray drying or of dropwise addition is used for encapsulation.

51. A method according to claim 49, characterised in that the aqueous solution of the alginate or alginate derivative is adjusted to a concentration of approximately 0.5 to 10% by weight, especially approximately 0.5 to 4% by weight.

52. A method according to claim 49, characterised in that the aqueous solution of chitosan or chitosan derivative is adjusted to a concentration of approximately 0.5 to 4% by weight, especially approximately 0.5 to 2% by weight.

53. A method according to claim 49, characterised in that alkali and/or alkaline earth salts, especially calcium chloride, are incorporated as hardening salts in the aqueous solution of chitosan or chitosan derivative.

54. A method according to claim 49, characterised in that incorporated in the starting solution and/or the final reaction mixture are additional additives in the form of pH, redox and/or conductivity-sensitive reagents, especially phenolphthalein or methyl orange, or additives in the form of silicon dioxide, porous materials, especially bentonite and/or activated carbon for reducing density.
